(19) United States
(12) Patent Application Publication
(10) Pub. No.: US 2018/0293852 A1
(43) Pub. Date: Oct. 11, 2018

(54) Remotely activated penlight illuminated tracking system for hunters, law enforcement, cave exploring and other sportsmen

(71) Applicant: Phil Vaught, Anderson, IN (US)

(72) Inventor: Phil Vaught, Anderson, IN (US)

(21) Appl. No.: 15/946,554

(22) Filed: Apr. 5, 2018

Related U.S. Application Data
(60) Provisional application No. 62/482,396, filed on Apr. 6, 2017.

(51) Int. Cl. G08B 5/38

(52) U.S. Cl. CPC G08B 5/38

(57) ABSTRACT

A remotely activated illuminated tracking system for hunters, law enforcement, cave explorer and other sportsmen to be used for marking trails and locations in outdoor areas. The system includes a transmitter, with a controller board and cycling encoder, an antenna and components for sending; one or more receivers, with an antenna, a decoder to match the cycling encoder rolling frequency, a power source, a controller with a timer, and one or more 360 degree, colored light emitting diodes; and a manner for removably securing the receiver to a branch, a tree, a post, a tree stand. This system allows the receiver on the object to be located by the operator of the remote control transmitter signaler from a distance away and to indicate, with a solid or flashing LED, the way from the operator to the object.

### CROSS-REFERENCE TO RELATED APPLICATIONS

This application claims the benefit of United States Provisional Patent Application Ser. No. 62/482,396 filed Apr. 6, 2017, by Phil Vaught and entitled “A remotely activated penlight illuminated tracking system for hunters, law enforcement, cave exploring and other sportsmen”.

### FIELD OF INVENTION

This invention relates to a remotely activated penlight illuminated tracking system for hunters and sportsmen. The instant invention is in the field of devices for trail marking used, for example, by hunters, law enforcement, cave exploring and other sportsmen. This invention pertains generally to the field of accessories used by outdoor sportsmen, such as hunters, to find their way outdoors (day or night), and more particularly to devices and methods for marking trails and location references in outdoor areas such as a forest. The present system, more particularly, is directed to a light device having light emitting diodes (LEDs) as the light source and which can be mounted in various manners for different uses in forests and outdoor areas used for hunting.

In general, the present invention relates to trail markers and a remotely activated trail marker system that are used to mark a trail for a person walking in the woods or other undeveloped land. The invention also pertains to devices to prevent a person from becoming lost, and more particularly, to a system of trail marker devices that optionally emit light and are communicative with one another to guide a person when in unfamiliar terrain. Finally, the invention relates to devices useful in locating an object, and more particularly, devices which utilize a remote control for activating, from some distance away from the object, a visual signal indicating the way to an object, whereby the object can be located by the operator of the remote control.

### FEDERALLY SPONSORED RESEARCH

None.

### SEQUENCE LISTING OR PROGRAM

None.

### BACKGROUND

### Field of Invention and Prior Art

As far as known, there are no remotely activated penlight illuminated tracking system for hunters and sportsmen. It is believed that this product is unique in its design and technologies.

Tree stands and other hunting blinds are typically camouflaged or otherwise made to blend into the surrounding landscape. In this manner, the tree stand or blind is hard to see by game animals. However, after a hunter sets up a tree stand or blind in a selected location, it is often difficult for the hunter to quickly find that location again without searching the area and alerting game animals to the presence of the hunter. It is for this reason that hunters often mark the trail to the position of their tree stand or hunting blind as they walk away from that position. Often hunters mark their trails with natural objects, such as sticks and rocks. But such material is not always conveniently available. As such, many hunters bring with them trail marking objects that are specifically intended for use in marking the trail to and from a hunting position.

People often encounter great difficulty in marking trails when traveling in unfamiliar wooded areas or the like. The problem is particularly aggravated in the case of young or inexperienced individuals and/or those who have a poor sense of direction. Consequently, many people have become hopelessly lost because they failed to mark their trail and/or become totally confused in their sense of direction. Also they need a way to mark known holes, ditches, swamps, etc. to mark a safe way to avoid them.

Heretofore, people traveling by foot relied on their sense of direction and/or memory (i.e. dead reckoning) when traveling over a trail in unfamiliar surroundings. Others have resorted to marking trails by breaking tree branches and/or setting up various signs by utilizing the natural materials found at hand, such as stones, branches, tree trunks and the like. However, the use of such natural material for marking trails frequently did not constitute a positive identification as such signs quickly lost their identity in the wilderness. Also such signs are easily overlooked, misunderstood or lost in their natural surroundings. Therefore, even though one attempted to mark trails by using the natural materials at hand, it did not assure such persons from becoming lost. The problem is even more aggravated if a hiker or camper planned an extensive trip into unknown wilderness, as for example, for several days, as the natural signs used for trail marking would tend to soon disappear, wash away or be altered by an animal or subsequent passer by. Thus, the natural materials heretofore utilized to mark a trail, at best, had only limited duration, and did not constitute a positive and lasting means to permanently mark a trail.

Hunters, hikers, explorers and participants in other outdoor activities often need or would like to know where they are or where they have been in a forest or other outdoor area. A hunter, for example, would like to be able to find his way back to a choice hunting location. He may want to let another hunter, who is to join him later, know where he is and what path he followed. A hunter may need to leave harvested game or equipment temporarily to obtain help to carry the game or equipment away, in which case, he needs to be able to find his way back to the spot of the kill relatively quickly.

### Problem Solved

The problem of becoming lost or disoriented when in unfamiliar terrain is ancient. In the familiar fairy story of Hansel and Gretel, when the children are led into the forest where they are to be abandoned, Hansel gathers white pebbles and leaves a trail which the children follow to return to their home. When taken into the woods a second time, Hansel has only breadcrumbs to leave as trail markers. Unfortunately, various animals eat the breadcrumbs, and the children are unable to find their way home.

Campers, hikers, explorers and the like, often encounter much difficulty in marking trails when traveling in unfamiliar wooded areas or the like. The problem is particularly aggravated in the case of young hikers, campers, explorers and/or for those who have a poor sense of direction. Consequently many persons have become hopelessly lost because they failed to mark their trail and/or became totally confused in their sense of direction.

It is well known to leave trail markers consisting of colored flags, sticks oriented in a certain manner, piles of stones in a specific shape or orientation, and many other such devices. While these may be useful in the daytime, they become virtually useless in the darkness of night. In addition, with such trail markers of the prior art, the direction to the next trail marker may not be obvious. What is needed is an extremely compact and inexpensive trail marking apparatus that is robust, is simple to use (i.e. is virtually “hands free”), has minimal electrical power requirements and can be employed in both clandestine and open trail/location marking modes.

### Prior Art

Finding one's way outdoors traditionally is accomplished with the help of distinctive landmarks, such as a particular rock, a stream or an unusual tree. However, this can be very difficult if one is not familiar with the surrounding environment, or distinctive landmarks are lacking. Outdoor location identification is particularly difficult in the night, when natural landmarks are not easily visible due to low ambient light levels or are altered in appearance by shadows. Thus, hunters and outdoor sportsman will often mark their trail as they proceed to or from a particular location. The marked trail can easily be followed to/from the location by the sportsman at a later date or by others who follow.

A variety of devices and methods are known for marking trails outdoors. Typically, such methods involve placing permanent or removable marks or monuments on the ground, trees or other objects, or leaving a trail of markers on or in the ground, trees, etc. Reflective trail markers have become popular because they provide an inexpensive, easy method of marking trails and are highly visible at night when a light source is shined on them. Also, the tape can be blocked by branches, trunks and other obstacles. Pieces of reflective tape, for example, are used to mark trails by placing the tape on trees or objects, but such tapes are often not easily securely applied and removed.

One type of reflective trail marker currently on the market resembles a thumbtack having a head, which is coated with a reflective coating, such as reflective paint. Such a marker can be pressed into a tree's bark easily with one hand. The ability to place a trail marker with only one hand is an important advantage, with one's hands usually occupied with other equipment or accessories when participating in outdoor activities. A series of such markers pressed into trees forms an easily visible trail. The reflective markers are made highly visible in the dark from a distance by shining light, e.g., a flashlight, onto them. However, the heads of these reflective markers are substantially flat, or form only a slight convex curvature. Thus, a light source must shine onto the head from a direction nearly perpendicular to the plane of the head for the reflected light to be visible to a person located at the light source. Also, such tacks can be difficult to remove from the trees or other structures in which they are placed. When employed on frequently used trails, such tacks can accumulate over time, by virtue of their being difficult to remove, and become an environmental eyesore or a misleading/distractive nuisance. Ornamental designs for similarly constructed trail markers are illustrated in U.S. Des. Pat. D445,710 to Lewis and U.S. Des. Pat. D357,428 to Lovelace.

Another reflective trail marker currently on the market resembles a tack having a cylindrical head, with the pin portion of the tack extending from one end of the cylinder. This type of trail marker is more easily placed in and removed from trees and other structures than the above described “thumbtack-type” marker. A reflective coating, of tape or paint, is placed substantially entirely about the cylindrical head. Such a reflective head reflects source light directly shined onto it from any angle (360.degree. reflection). However, for any particular angle of incident source light, the actual reflective area can be effectively very small. Therefore, the reflective marker's effective reflective distance is always relatively short. Moreover, since the reflective head reflects source light shined onto it from any angle, a trail formed by such markers can be easily detected by shining a source light in the general area of the trail. This can be a disadvantage in some cases, such as where the person marking the trail (such as a choice hunting or fishing spot) wishes to keep the trail secret, and thus minimize the possibility of others discovering the trail. Reflective trail markers which reflect light in all directions (360.degree.reflection) can also cause confusion in areas which are marked with several trails. A person shining a light into a forest with several trails marked with such (360.degree. reflection) markers may simultaneously see reflections from markers belonging to different trails, making it difficult to discern the desired trail to be followed.

U.S. Pat. No. 6,299,379 to Lewis describes a trail marker having a generally “hour-glass” shaped marker head characterized by a central portion which is straddled by opposed end portions. The central portion of the marker head has one or more sidewall surfaces, which are light reflective. The sidewall surfaces of the marker head may be formed of a reflective material, or may be made reflective by applying reflective paint or tape thereto. The central portion of the marker head is formed to define four flat reflective sidewall surfaces at right angles to each other. This shape is characterized as enhancing the reflective surface area of the central portion of the marker head. The top and bottom cap portions of the marker head are non-reflective, and extend beyond the sidewalls of the central portion. The non-reflective cap portions are stated to prevent illumination of and reflection from the central portion of the marker head at angles varying substantially from perpendicular to the reflective sidewall surfaces of the central portion along the axis of the central portion. A pin extends from one end of the marker head, to enable attachment of the marker to a support member, such as a tree.

Another class of trail markers art is exemplified by U.S. Pat. No. 3,685,482 to Ryder and U.S. Patent Application Publication No.: 2002/0152948 to Percle. These devices typically employ a flexible, elongated member and means for fastening one end of the member to a fixed object such as a tree branch. Such markers can be brightly colored and tend to move with air currents to draw attention from any direction. Although inexpensive and easily attached, these markers are only visible with sufficient ambient light. Hours of dawn and dusk tend to create deep shadows, which can obscure or hide this type of marker. The use of such markers in a camouflage motif is also known for more clandestine applications. For example, see U.S. Pat. No. 6,712,286 to Baxter et al.

U.S. Pat. No. 5,000,111 to Gibson and U.S. Patent Application Publications 2004/0016786 to Banda, 2004/0206294 to Cavanaugh and 2005/0006423 to Kjeldsen each disclose a trail marking device including an elongated roll of brightly colored and/or reflective material which, in application, is carried by the trail blazer, who periodically severs a short length of the material and secures it at a waypoint along his trail.

U.S. Pat. No. 5,669,327 to Beebe describes a trail marking kit including a plurality of reusable colored tags which are made of special biodegradable material. Each tag contains means for attachment to a tree limb or the like to visually mark the trail to allow the user to return to his original destination by visually following the markers. The markers are sized for spacing of 100 or more yards there between, depending upon the density of the vegetation. Upon returning from the hike or journey, the user simply dislodges the previously placed markers from their respective fixed locations.

All of the forgoing prior art approaches require the user to pause at each waypoint and to study the terrain in order to locate the next waypoint. Although this may be easy in bright daylight and in open terrain, the onset of darkness and/or heavy undergrowth can make this more difficult. In low light conditions or dark, the user must carry a light source (e.g. flashlight) and continuously scan its beam back and forth in his field of view in order to locate his next waypoint. This can be difficult when also carrying other equipment, a weapon and/or captured game. Furthermore, if the flashlight is inadvertently lost, damaged or its batteries fail, the upcoming trail markings are of little value. Lastly, the need to continuously scan a flashlight beam off into the distance in darkened terrain while walking an unknown trail can distract the attention of the user from upcoming snags, overhanging branches, obstacles and unseen hazards and holes.

The forgoing trail marker approaches, although having potential limited utility, all have shortcomings, in that they inherently reveal themselves to passers-by, reflecting light emanating from any artificial or natural (i.e. sun, moon, lightening, etc.) source which happens to be fortuitously positioned with respect to the observer. This problem is particularly acute in environments, such as thickly grown forests, that contain few, if any, naturally occurring reflective surfaces. In such a situation, a reflected light in the distance naturally draws (unwanted) attention. Therefore, none of this prior art anticipates the Vaught solution. Likewise, the prior art, alone or in combination, fails to have the components and inherent ability to solve the problem like Vaught. This is a longstanding need that has gone without a solution until now. Vaught is therefore not considered an obvious solution to the problem solved.

### SUMMARY OF THE INVENTION

The preferred embodiment of a remotely activated penlight illuminated tracking system for hunters and sportsmen is comprised of: (a) a transmitter comprising push buttons to activate the transmitter, a controller board, an encoder that switches frequencies for security and multiple users, a battery/electrical power source, a transmitter case, an antenna/sending means, and a transmitter generator coil; (b) at least one receiver with an antenna and coil, a Decoder to match cycling encoder rolling frequency, a battery/electrical power source, a timer for timed out LEDs, a controller circuit board, a strobe circuit, at least one light emitting diode (LED) preferably in 360 degree in various well seen colors (red R, green G, blue B, white W, yellow Y etc.), an on-off switch, a cap and a body; and (c) a means for removably securing the receiver—such as an attachment pin; an alternative lanyard 65 to attach receiver 46 to point of use, an alternative right angle pin 66 to attach receiver 46 at point of use, and an alternative alligator push clip 67 to secure receiver 46 at point of use—to an object such as a tree, a post, a tree stand or the like wherein the object can be located by the operator of the remote control transmitter signaling to the at least one receiver; and wherein the system has timed and flashing LEDS which are useful in locating an object where the system utilizes a remote control transmitter for activating the receiver, from some distance away from the object, and the receiver has a timed, solid or flashing visual signal indicating the way to an object.

The newly invented remotely activated penlight—or integrated into a flashlight—for illuminated tracking system for hunters, law enforcement, cave exploring and other sportsmen can be manufactured at low volumes by very simple means and in high volume production by more complex and controlled systems.

### Objects and Advantages

There are several objects and advantages of the remotely activated penlight illuminated tracking system for hunters, law enforcement, cave exploring and other sportsmen. There are currently no known illuminated tracking systems that are effective at providing the objects of this invention.

The remotely activated penlight illuminated tracking system for hunters and sportsmen has various advantages and benefits:

TABLE A
Advantages and Benefits

| Item | Advantages |
|---|---|
| 1 | reduces time for hunter to get to tree stand or |
| | hunting position |
| 2 | provides safe way to reduce chance of hunter getting |
| | lost |
| 3 | supports location awareness of hunter traveling |
| | through dark forest |
| 4 | does not alert game |
| 5 | provides by an intermittent strobe/flashing light or |
| | solid light that is easy to follow |
| 6 | is compact and light for easy carrying |
| 7 | is a silent means to signal hunter and not game |
| 8 | provides multiple light colors for multiple users or |
| | different trails |

Finally, other advantages and additional features of the present remotely activated penlight illuminated tracking system for hunters and sportsmen will be more apparent from the accompanying drawings and from the full description of the device. For one skilled in the art of illuminated tracking systems and devices, it is readily understood that the features shown in the examples with this product are readily adapted to other types of illuminated tracking systems and devices.

### DESCRIPTION OF THE DRAWINGS—FIGURES

The accompanying drawings, which are incorporated in and constitute a part of this specification, illustrate an embodiment of the remotely activated penlight illuminated tracking system for hunters, law enforcement, cave exploring and other sportsmen that is preferred. The drawings together with the summary description given above and a detailed description given below serve to explain the principles of the illuminated tracking system. It is understood, however, that the remotely activated penlight illuminated tracking system for hunters and sportsmen is not limited to only the precise arrangements and instrumentalities shown.

FIGS. 1 A through 1 E are sketches of the remote penlight illuminated tracking system for hunters and sportsmen.

FIGS. 2 A through 2 H are sketches of the remote penlight illumination device with components and features noted.

FIG. 3 is a sketch of how the remotely activated penlight illumination tracking system is used.

FIG. 4 is another sketch of the remotely activated illumination system in use.

FIG. 5 is a further sketch of the remotely activated illuminated tracking system in use.

FIG. 6 is a further sketch of the remotely activated illuminated tracking system in use for cave exploring.

FIG. 7 is a sketch of the remotely activated illuminated tracking system in use as a law enforcement or search and rescue search mission.

### DESCRIPTION OF THE DRAWINGS—REFERENCE NUMERALS

The following list refers to the drawings:

TABLE B
Reference numbers

| Ref # | Description |
|---|---|
| 30 | remote activated penlight illuminated tracking |
| | system 30 for hunters, law enforcement, cave |
| | exploring and other sportsmen |
| 35 | control diagram 35 of the transmitter for the |
| | system 30 |
| 36 | push buttons 36 to activate the transmitter |
| 37 | controller board 37 |
| 38 | encoder 38 that allows the circulating code to |
| | switch frequencies for security and multiple |
| | users |
| 39 | battery/electrical power source 39 |
| 40 | transmitter device 40 |
| 40A | transmitter case 40A |
| 41 | antenna/sending means 41 |
| 42 | transmitter generator coil 42 |
| 45 | control diagram 45 for the receiver 46 |
| 46 | receiver 46 |
| 47 | receiver antenna 47 |
| 48 | receiver coil 48 |
| 49 | decoder 49 to match cycling encoder 38 rolling |
| | frequency |
| 50 | battery/electrical power source 50 |
| 50A | battery holder 50A |
| 51 | timer 51 for timed out of light (1-3 minutes) |
| 51A | push buttons 51A to activate the LEDs to check |
| | battery |
| 52 | controller circuit board 52 |
| 53 | strobe 53 circuit |
| 54 | light emitting diode (LED) 54 preferably in |
| | 360 degree in various well seen colors - red |
| | R, green G, blue B, white W, yellow Y etc. |
| 55 | on-off switch 55 |
| 56 | cap 56 |
| 57 | means 57 for securing cap 56 to body 58 |
| 58 | receiver body 58 |
| 59 | contact 59 LED 54 to battery holder 50A |
| 60 | preferred attachment pin 60 to secure pivot |
| | pin 63 at point of use |
| 61 | latch 61 to hold pin 60 to receiver 46 |
| 62 | means 62 for removably securing latch 61 to |
| | receiver 46 |
| 63 | pivot pin 63 for rotationally securing pin 60 |
| | to receiver 46 |
| 64 | means 64 for securing pivot pin 62 to receiver |
| | 46 |
| 65 | alternative lanyard 65 to attach receiver 46 |
| | to point of use |
| 66 | alternative right angle pin 66 to attach |
| | receiver 46 at point of use |
| 67 | alternative alligator push clip 67 to secure |
| | receiver 46 at point of use |
| 68 | ground spike 68 to hold receiver 46 |
| 70 | hunter 70 |
| 71 | weapon 71 |
| 72 | tree stand 72 |
| 73 | all-terrain vehicle (ATV) 73 |
| 74 | game/carcass carrier 74 |
| 75 | pathway 75 of LED strobes 46 |
| 75A | alternate pathway 75A of LED strobes 46 |
| 77 | tree bark 77 |
| 78 | tree 78 |
| 79 | tree branch 79 |
| 80 | forest 80 with system 30 in use |
| 81 | cave 81 for exploring with multiple paths |
| 82 | search field 82 for law enforcement or search |
| | and rescue searches |

### DETAILED DESCRIPTION OF PREFERRED EMBODIMENT

The present application relates to a remotely activated penlight illuminated tracking system for hunters, law enforcement, cave exploring and other sportsmen. It is in the field of devices for trail marking used, for example, by hunters. This pertains generally to the field of accessories used by outdoor sportsmen to find their way outdoors, and more particularly, to devices and methods for marking trails and location references in outdoor areas such as a forest. More particularly, the system is directed to a manner using a light device having light emitting diodes (LEDs) as the light source. These LED devices can be mounted in various manners for different uses in forests and outdoor areas used for hunting. These trail markers are used to remotely mark a trail for a person walking in the woods or other undeveloped land. The invention also pertains to devices to prevent a person from becoming lost and to guide a person when in unfamiliar terrain. The system and LEDS devices are useful in locating an object in which the devices utilize a remote control for activating, from some distance away from the object, and a visual signal indicating the way to an object.

The advantages for the remotely activated penlight illuminated tracking system for hunters and sportsmen 30 are listed above in the introduction. Succinctly the benefits are that the device:
reduces time for hunter to get to tree stand or hunting position;
provides safe way to reduce chance of hunter getting lost;
supports location awareness of hunter traveling through dark forest;
does not alert game;
provides by an intermittent strobe/flashing light or solid light that is easy to follow;
is compact and light for easy carrying;
is a silent means to signal hunter and not game;
provides multiple light colors for multiple users or different trails.

The preferred embodiment of a remotely activated penlight illuminated tracking system for hunters and sportsmen is comprised of: (a) a transmitter comprising push buttons to activate the transmitter, a controller board, an encoder that switches frequencies for security and multiple users, a battery/electrical power source, a transmitter case, an antenna/sending means, and a transmitter generator coil; (b) at least one receiver with an antenna and coil, a Decoder to match cycling encoder rolling frequency, a battery/electrical power source, a timer for timed out LEDs, a controller circuit board, a strobe circuit, at least one light emitting diode (LED) preferably in 360 degree in various well seen colors (red R, green G, blue B, white W, yellow Y etc.), an on-off switch, a cap and a body; and (c) a means for removably securing the receiver—such as an attachment pin; an alternative lanyard 65 to attach receiver 46 to point of use, an alternative right angle pin 66 to attach receiver 46 at point of use, and an alternative alligator push clip 67 to secure receiver 46 at point of use—to an object such as a tree, a post, a tree stand or the like wherein the object can be located by the operator of the remote control transmitter signaling to the at least one receiver; and wherein the system has timed and solid or flashing LEDS which are useful in locating an object where the system utilizes a remote control transmitter for activating the receiver, from some distance away from the object, and the receiver has a timed, flashing visual signal indicating the way to an object.

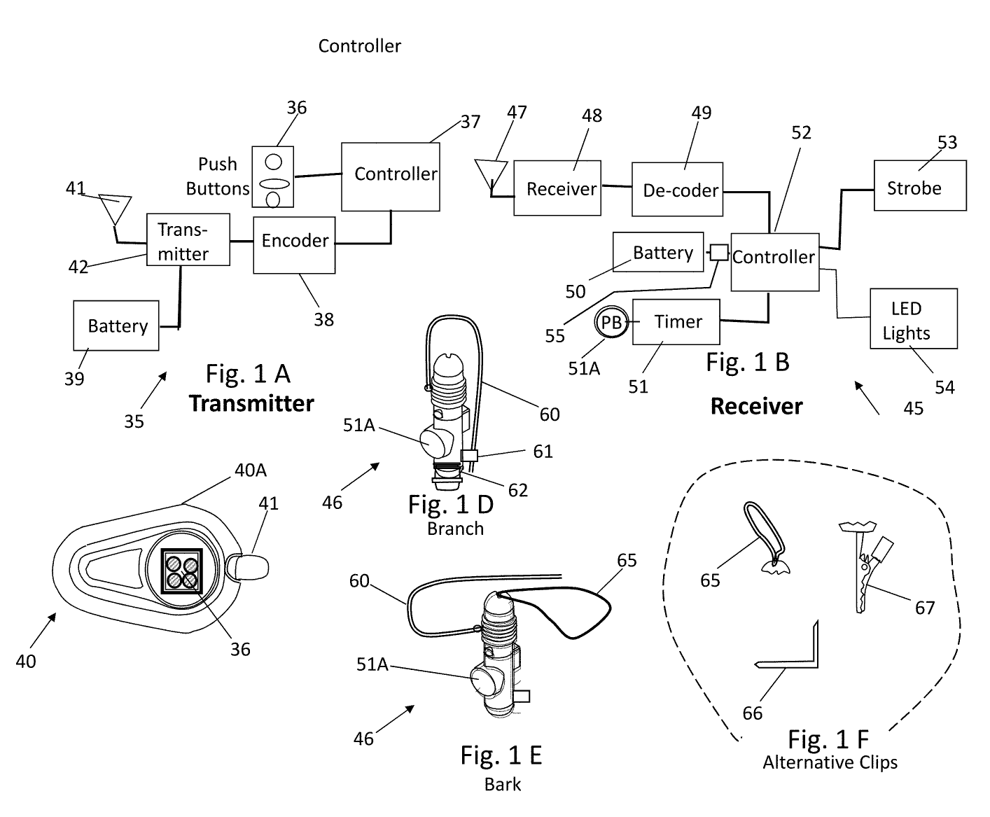

There is shown in FIGS. 1-7 a complete description and operative embodiment of the remotely activated penlight illuminated tracking system for hunters and sportsmen. In the drawings and illustrations, one notes well that the FIGS. 1-7 demonstrate the general configuration and use of this product. The various example uses are in the operation and use section, below.

The accompanying drawings, which are incorporated in and constitute a part of this specification, illustrate an embodiment of the remotely activated penlight illuminated tracking system 30 for hunters and sportsmen that is preferred. The drawings together with the summary description given above and a detailed description given below serve to explain the principles of the remotely activated penlight illuminated tracking system 30 for hunters and sportsmen. It is understood, however, that the illuminated tracking systems 30 is not limited to only the precise arrangements and instrumentalities shown. Other examples of remotely activated penlight illuminated tracking system for hunters and sportsmen and uses are still understood by one skilled in the art of illuminated tracking systems and devices to be within the scope and spirit shown here.

FIGS. 1 A through 1 E are sketches of the remote penlight illuminated tracking system 30 for hunters and sportsmen. The main receiver and transmitter components and control/block diagrams are shown here. These drawings reveal the following components and features: a control diagram 35 of the transmitter for the system 30; push buttons 36 to activate the transmitter; controller board 37; an encoder 38 that allows the circulating code to switch frequencies for security; battery/electrical power source 39; a transmitter device 40; a transmitter case 40A; an antenna/sending means 41; a transmitter generator coil 42; a control diagram 45 for the receiver 46; a receiver 46; a receiver antenna 47 and a receiver coil 48; a decoder 49 to match cycling encoder 38 rolling frequency; a battery/electrical power source 50 battery holder 50A; a timer 51 for timed out of light (1-3 minutes); a set of push buttons 51A to activate the LEDs to check battery; a controller circuit board 52; a strobe 53 circuit; a light emitting diode (LED) 54 preferably in 360 degree in various well seen colors—red R, green G, blue B, white W, yellow Y etc.; an on-off switch 55; the preferred attachment pin 60 to secure pivot pin 63 at point of use; a latch 61 to hold pin 60 to receiver 46; a means 62 for removably securing latch 61 to receiver 46; the preferred attachment pin 60 to secure pivot pin 63 at point of use latch 61 to hold pin 60 to receiver 46; and a means 62 for removably securing latch 61 to receiver 46.

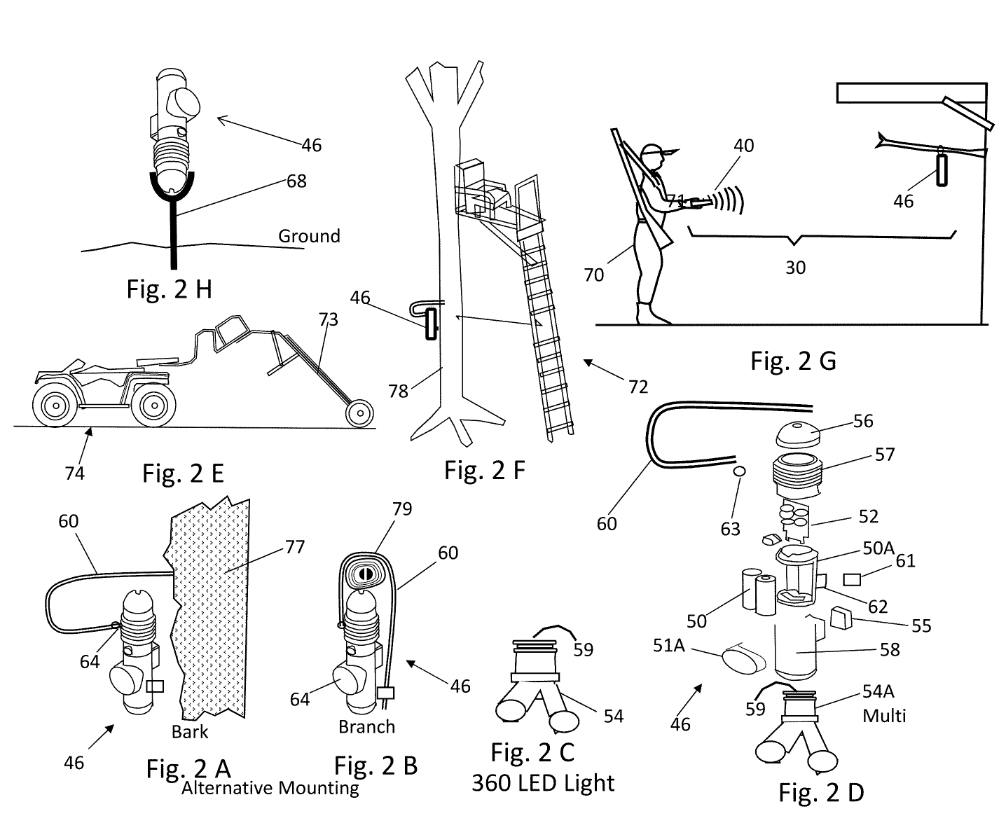

FIGS. 2 A through 2 H are sketches of the remote penlight illumination system 30 with components and features noted. In these drawings there are shown: a remote activated penlight illuminated tracking system 30 for hunters and sportsmen; a transmitter device 40; a receiver 46; a battery/electrical power source 50; a battery holder 50A; a timer 51 for timed out of light (1-3 minutes); at least one push button 51A to activate the LEDs to check battery; a controller circuit board 52; a strobe 53 circuit; at least one light emitting diode (LED) 54 preferably in 360 degree in various well seen colors—red R, green G, blue B, white W, yellow Y etc.; an on-off switch 55; a cap 56; a means 57 for securing cap 56 to body 58; a receiver body 58; a contact 59 LED 54 to battery holder 50A; the preferred attachment pin 60 to secure a pivot pin 63 at the point of use; a latch 61 to hold pin 60 to receiver 46; a means 62 for removably securing latch 61 to receiver 46; a pivot pin 63 for rotationally securing pin 60 to receiver 46; a means 64 for securing pivot pin 62 to receiver 46; the preferred attachment pin 60 to secure a pivot pin 63 at the point of use; a latch 61 to hold pin 60 to receiver 46; a means 62 for removably securing latch 61 to receiver 46; an alternative lanyard 65 to attach receiver 46 to point of use; an alternative right angle pin 66 to attach receiver 46 at point of use; an alternative alligator push clip 67 to secure receiver 46 at point of use; a ground spike 68 to hold receiver 46; a hunter 70; a weapon 71; a tree stand 72, an all-terrain vehicle (ATV) 73; a game/carcass carrier 74; a tree bark 77; a tree 78; and a tree branch 79.

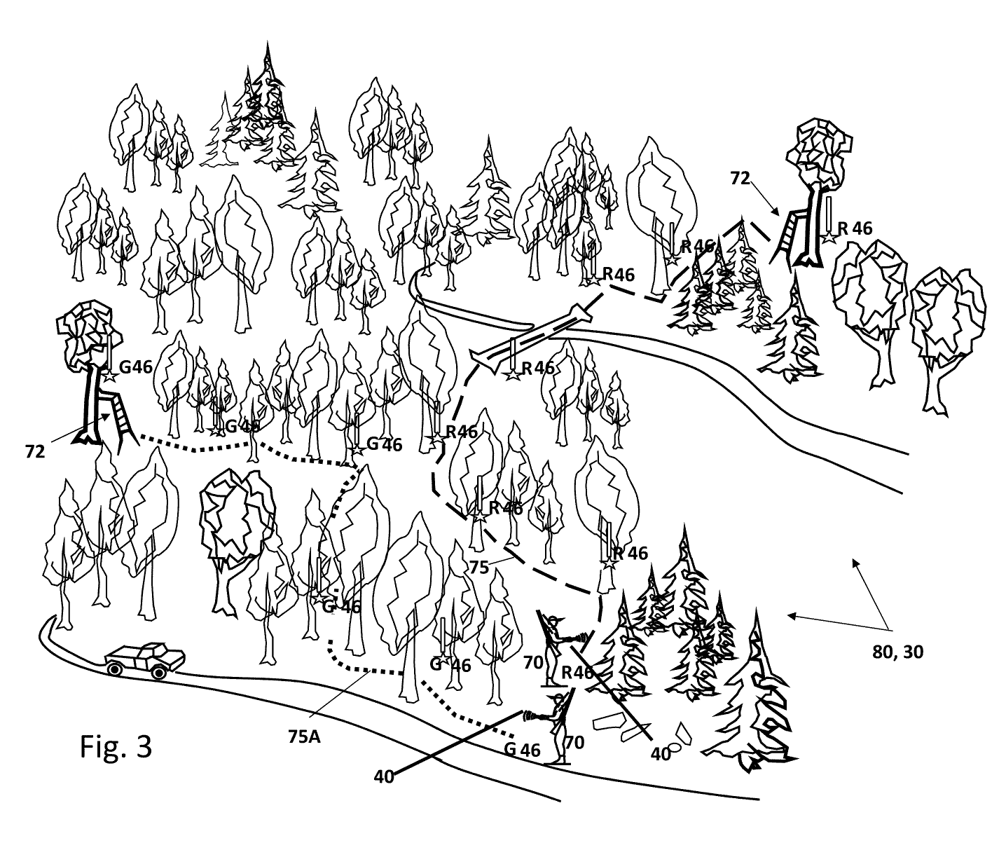

FIGS. 3, 4, 5, 6 and 7 are related to the use of the remotely activated penlight illuminated tracking system 30 for hunters and sportsmen. These Figures are discussed below in the Operations section.

The details mentioned here are exemplary and not limiting. Other specific components and manners specific to describing a remotely activated penlight illuminated tracking system 39 for hunters and sportsmen may be added as a person having ordinary skill in the field of the art of illuminated tracking systems and devices and their uses well appreciates.

### Operation of the Preferred Embodiment

The remotely activated penlight illuminated tracking system 30 for hunters and sportsmen has been described in the above embodiment. The manner of how the device operates is described below. One notes well that the description above and the operation described here must be taken together to fully illustrate the full concept of the remotely activated penlight illuminated tracking system 30 for hunters and sportsmen. The preferred embodiment of a remotely activated penlight illuminated tracking system for hunters and sportsmen is comprised of: (a) a transmitter comprising push buttons to activate the transmitter, a controller board, an encoder that switches frequencies for security, a battery/electrical power source, a transmitter case, an antenna/sending means, and a transmitter generator coil; (b) at least one receiver with an antenna and coil, a Decoder to match cycling encoder rolling frequency, a battery/electrical power source, a timer for timed out LEDs, a controller circuit board, a strobe circuit, at least one light emitting diode (LED) preferably in 360 degree in various well seen colors (red R, green G, blue B, white W, yellow Y etc.), an on-off switch, a cap and a body; and (c) a means for removably securing the receiver—such as an attachment pin; an alternative lanyard 65 to attach receiver 46 to point of use, an alternative right angle pin 66 to attach receiver 46 at point of use, and an alternative alligator push clip 67 to secure receiver 46 at point of use—to an object such as a tree, a post, a tree stand or the like wherein the object can be located by the operator of the remote control transmitter signaling to the at least one receiver; and wherein the system has timed and flashing LEDS which are useful in locating an object where the system utilizes a remote control transmitter for activating the receiver, from some distance away from the object, and the receiver has a timed, flashing visual signal indicating the way to an object.

The remotely activated penlight illuminated tracking system 30 for hunters and sportsmen operates by placing batteries 39,50 into the transmitter 40 and the receiver(s) 46. A hunter 70 must choose which color of LED 54 to use, so a forest 80 may have a single pathway 75 and more alternative pathways 75A with different colors and different (or the same) hunter. Once the batteries are inserted, one should check the operation. This is accomplished by pushing the transmitter button 36 and letting the receiver 46 light 54 flash until it “times out”. Next, the hunter 70 switches off the power switch 51A to the receivers 46 for storage and for carrying to the woods. At the forest/woods 80, choose an entry point, then start placing the receiver(s) 46 on trees 78 and posts about every 125 to 150 yards or less with thick brush. One 70 should take care to have a line of sight between each receiver 46 if possible. As each receiver 46 is placed, turn on the battery switch 51A and then push the transmitter button 36 to check the operation. Follow a pathway 75 to the desired object (tree stand 72 or clearing or special location to hunt). Use the system when traversing to and from the tree stand 72. When the season is complete, remove the receivers 46.

FIG. 3 is a sketch of how the remotely activated penlight illumination tracking system is used. The drawing shows: a remote activated penlight illuminated tracking system 30 for hunters and sportsmen; a transmitter device 40; a receiver 46 with light emitting diodes (LED) 54 preferably in 360 degree in various well seen colors—red R, green G, blue B, white W, yellow Y etc.; a hunter 70; a tree stand 72; a pathway 75 of LED strobes 46; an alternate pathway 75A of LED strobes 46; and a forest 80 with the system 30 in use.

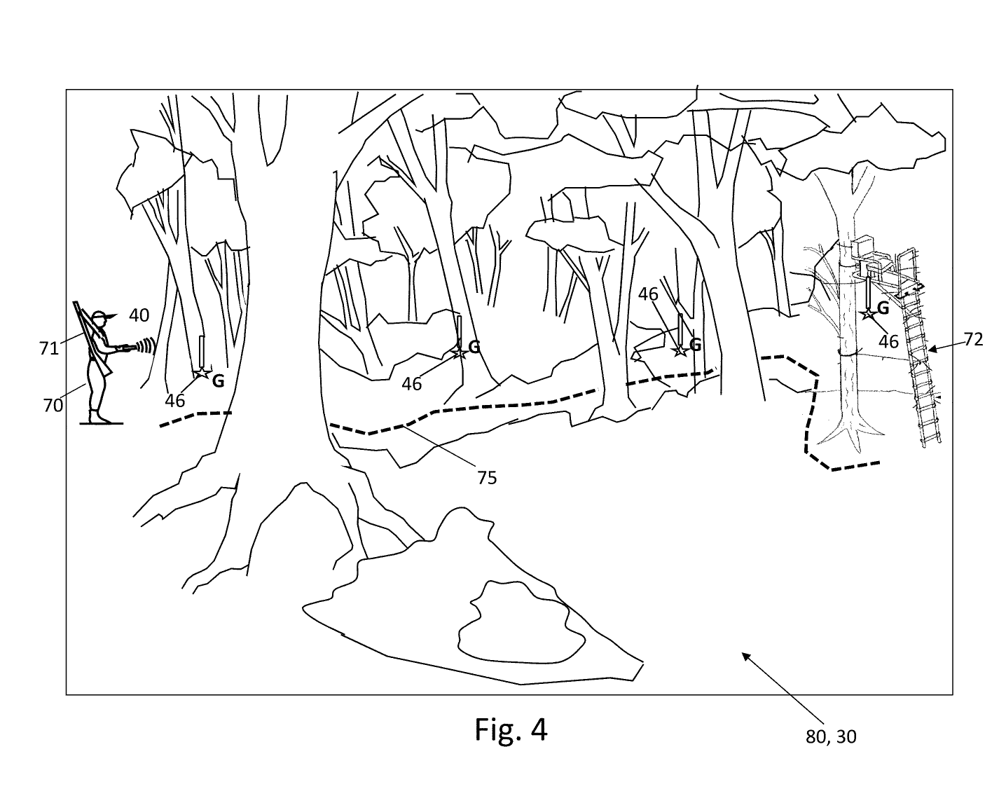

FIG. 4 is another sketch of the remotely activated illumination system in use. This is a different hunting venue but still show the following: a remote activated penlight illuminated tracking system 30 for hunters and sportsmen; a transmitter device 40; a receiver 46 with light emitting diodes (LED) 54 preferably in 360 degree in various well seen colors—red R, green G, blue B, white W, yellow Y etc.; a hunter 70; a tree stand 72; a pathway 75 of LED strobes 46; and a forest 80 with the system 30 in use.

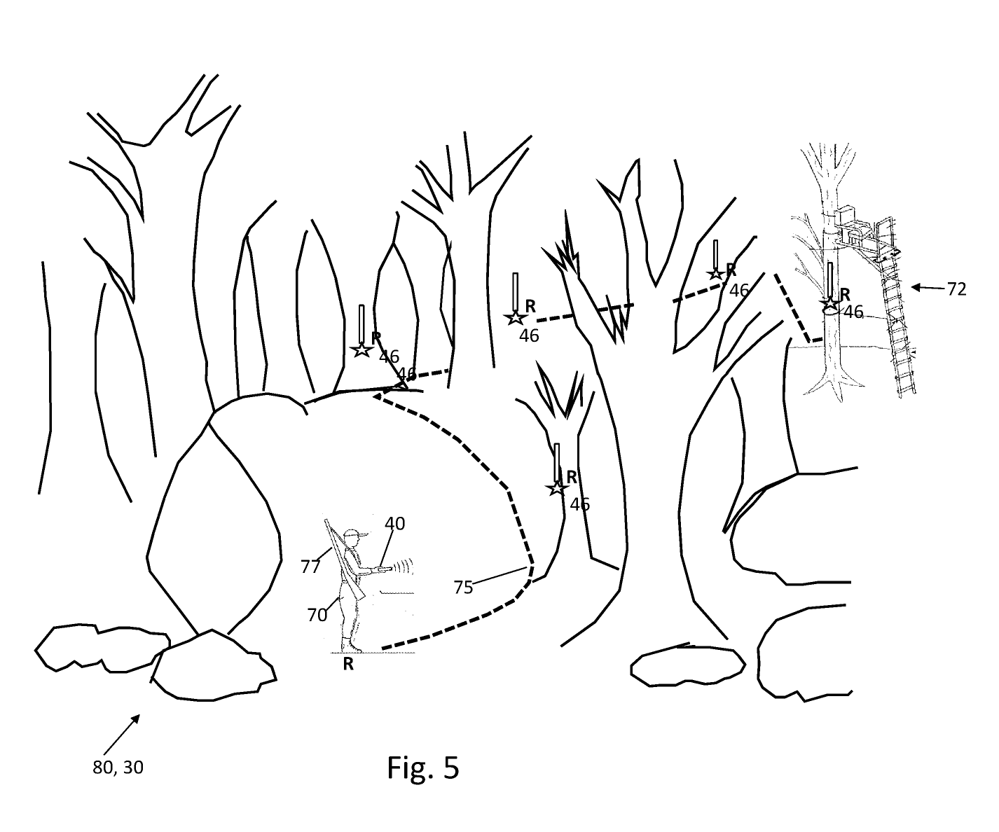

FIG. 5 is a further sketch of the remotely activated illuminated tracking system in use. This is a final example of use. The components and depictions shown here are: a remote activated penlight illuminated tracking system 30 for hunters and sportsmen; a transmitter device 40; a receiver 46 with light emitting diodes (LED) 54 preferably in 360 degree in various well seen colors—red R, green G, blue B, white W, yellow Y etc.; a hunter 70; a tree stand 72; a pathway 75 of LED strobes 46; and a forest 80 with the system 30 in use.

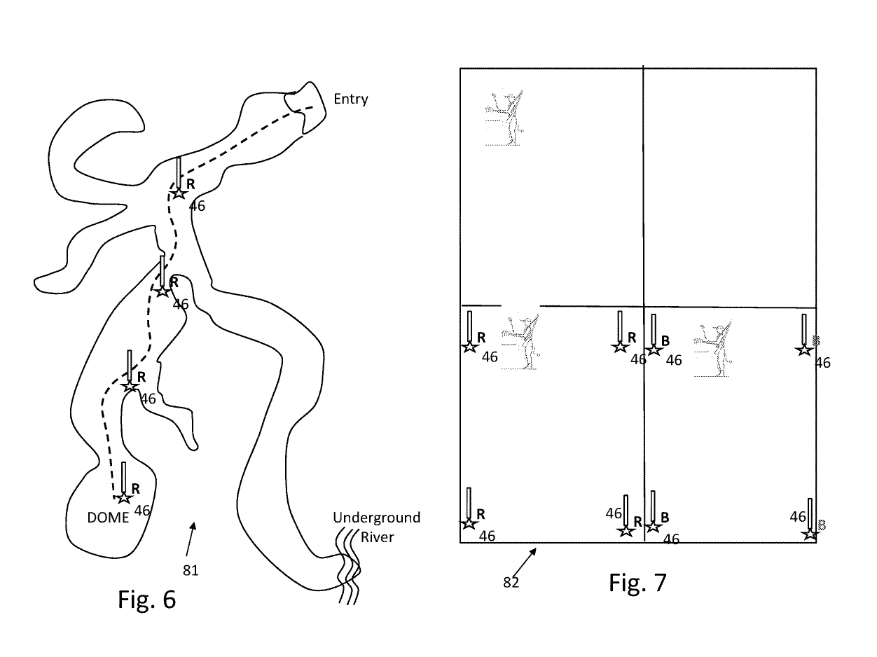

FIG. 6 is a further sketch of the remotely activated illuminated tracking system in use for cave exploring. The explorers mark the cave 81 with the receivers 46 to assure the return trip or followers know their location or path.

FIG. 7 is a sketch of the remotely activated illuminated tracking system in use as a law enforcement or search and rescue search mission. The search party marks areas searched with the receivers 46 to assure the entire search field 82 has been covered and no areas are missed.

Many uses are anticipated for the remotely activated penlight illuminated tracking system 30 for hunters and sportsmen. Some examples, and not limitations, are shown in the following Table.

| ITEM | DESCRIPTION |
|---|---|
| 1 | Enter and exit to tree stand in |
| | dense forests |
| 2 | Pathway marking for night hiking |
| 3 | Emergency medical night rescues |
| | for mapping return trip with |
| | victim |
| 4 | Law enforcement night operations |
| | for return trip with suspect |
| 5 | Cave exploring |
| 6 | law enforcement or search and |
| | rescue search mission |

With this description it is to be understood that the remotely activated penlight illuminated tracking system 30 for hunters, law enforcement, cave exploring and other sportsmen is not to be limited to only the disclosed embodiment of product. The features of the remotely activated penlight illuminated tracking system 30 for hunters and sportsmen are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. A remotely activated and illuminated tracking system (30) for a use by an operator to locate an object, the system is comprised of:
(a) a transmitter;
(b) at least one receiver; and
(c) a means for removably securing the receiver to an object
wherein the object can be located by the operator of the remote control transmitter signaling to the at least one receiver; and wherein the system has timed and flashing LEDS which are useful in locating the object where the system utilizes a remote control transmitter for activating the receiver, from some distance away from the object, and the receiver has a timed, solid or flashing visual signal indicating the way to the object.

2. The remotely activated and illuminated tracking system (30) according to claim 1 further wherein the transmitter is further comprising a cycling encoder that switches frequencies for security and multiple users and wherein the at least one receiver is further comprising a Decoder to match the cycling encoder rolling frequency.

3. The remotely activated and illuminated tracking system (30) according to claim 1 further wherein the transmitter is further comprising push buttons to activate the transmitter consisting of a controller board, an encoder that switches frequencies for security and multiple users, a battery/electrical power source, a transmitter case, an antenna/sending means, and a transmitter generator coil.

4. The remotely activated and illuminated tracking system (30) according to claim 1 wherein the receiver is further comprising an antenna and coil, a decoder to match cycling encoder rolling frequency, a battery/electrical power source, a timer for timed out LEDs, a controller circuit board, a strobe circuit, at least one light emitting diode (LED) preferably in 360 degree in various well seen colors (red R, green G, blue B, white W, yellow Y etc.), an on-off switch, a cap and a body.

5. The remotely activated and illuminated tracking system (30) according to claim 1 wherein the at least one receiver is encased in a penlight.

6. The remotely activated and illuminated tracking system (30) according to claim 1 wherein the means for removably securing the receiver to an object is selected from a group consisting of an attachment pin, a lanyard 65, a right angle pin 66, and an alligator push clip 67 all the said means to attach the receiver to a point of a use.

7. The remotely activated and illuminated tracking system (30) according to claim 1 wherein the object is selected from a group consisting of a tree, a post, a tree stand, and a fence post.

8. The remotely activated and illuminated tracking system (30) according to claim 1 wherein the use is selected from a group consisting of to enter and exit a tree stand in a dense forest, to mark a pathway for a night hiking, to make emergency and medical night rescues by mapping a return trip with a victim, to undertake night operations law enforcement for a return trip with a suspect, to explore caves, and to make a search and rescue search mission.

9. The remotely activated and illuminated tracking system (30) according to claim 1 wherein the operator is selected from a group consisting of hunters, sportsmen, sportswomen, law enforcement individuals, cave explorers, hikers, and participants in outdoor activities.

10. A remotely activated and illuminated tracking system for a use by an operator to locate an object, the system is comprised of:
(a) a transmitter comprising push buttons to activate the transmitter consisting of a controller board, an encoder that switches frequencies for security and multiple users, a battery/electrical power source, a transmitter case, an antenna/sending means, and a transmitter generator coil;
(b) at least one receiver with an antenna and coil, a decoder to match cycling encoder rolling frequency, a battery/electrical power source, a timer for timed out LEDs, a controller circuit board, a strobe circuit, at least one light emitting diode (LED) preferably in 360 degree in various well seen colors (red R, green G, blue B, white W, yellow Y etc.), an on-off switch, a cap and a body; and
(c) a means for removably securing the receiver to an object
wherein the object can be located by the operator of the remote control transmitter signaling to the at least one receiver; and wherein the system has timed and flashing LEDS which are useful in locating the object where the system utilizes a remote control transmitter for activating the receiver, from some distance away from the object, and the receiver has a timed, solid or flashing visual signal indicating the way to the object.

11. The remotely activated and illuminated tracking system (30) according to claim 10 wherein the at least one receiver is encased in a penlight.

12. The remotely activated and illuminated tracking system (30) according to claim 10 wherein the means for removably securing the receiver to an object is selected from a group consisting of an attachment pin, a lanyard 65, a right angle pin 66, and an alligator push clip 67 all the said means to attach the receiver to a point of a use.

13. The remotely activated and illuminated tracking system (30) according to claim 10 wherein the object is selected from a group consisting of a tree, a post, a tree stand, and a fence post.

14. The remotely activated and illuminated tracking system (30) according to claim 10 wherein the use is selected from a group consisting of to enter and exit a tree stand in a dense forest, to mark a pathway for a night hiking, to make emergency and medical night rescues by mapping a return trip with a victim, to undertake night operations law enforcement for a return trip with a suspect, to explore caves, and to make a search and rescue search mission.

15. The remotely activated and illuminated tracking system (30) according to claim 10 wherein the operator is selected from a group consisting of hunters, sportsmen, sportswomen, law enforcement individuals, cave explorers, hikers, and participants in outdoor activities.
